(19) United States
(12) Patent Application Publication
(10) Pub. No.: US 2011/0076450 A1
(43) Pub. Date: Mar. 31, 2011

(54) TITANIUM DIOXIDE COATINGS AND METHODS OF FORMING IMPROVED TITANIUM DIOXIDE COATINGS

(76) Inventor: Pramod K. SHARMA, Ann Arbor, MI (US)

(21) Appl. No.: 12/569,177

(22) Filed: Sep. 29, 2009

(51) Int. Cl. B32B 3/00; B05D 3/02; B05D 3/10

(52) U.S. Cl. 428/141; 427/372.2; 427/307

(57) ABSTRACT

Methods for forming titanium dioxide coatings are disclosed. Sol-gel compositions may be coated on a substrate having a roughened surface, and subsequently the coated substrate may be heated at a temperature sufficient to form an anatase titanium dioxide coating. Substrates having roughened surfaces and comprising such coatings are also disclosed.

### FIELD

The present invention relates generally to titanium dioxide coatings formed on roughened surfaces and methods of forming titanium dioxide coatings on roughened surfaces.

### BACKGROUND

Titanium dioxide (TiO₂, also know as titania) has been widely studied because of its potential photocatalytic applications. Unmodified titanium dioxide only absorbs ultraviolet (UV) radiation. When UV light is illuminated on titanium dioxide, electron-hole pairs are generated. Electrons are generated in the conduction band and holes are generated in the valence band. The electron and hole pairs reduce and oxidize, respectively, adsorbates on the surface of the titanium dioxide, producing radical species such as OH⁻ and O₂⁻. Such radicals may decompose certain organic compounds. As a result, titanium dioxide coatings have found use in antimicrobial and self-cleaning coatings, for example on windows.

To activate the titanium dioxide to photogenerate these electron-hole pairs (i.e. photocatalytic activity), and thus to provide the titanium dioxide with antimicrobial and/or self-cleaning properties, titanium dioxide must be regularly dosed with photons of energy greater than or equal to about 3.0 eV (i.e., radiation having a wavelength less than about 413 nm). Depending on variables such as the structure, ingredients, and texture of titanium dioxide coatings, for example, dosing may takes several hours, such as, for example, 6 hours or more. Antimicrobial titanium dioxide coatings, therefore, must generally be exposed to UV radiation for at least 6 hours before achieving the full photocatalytic effect.

Efforts have been made to extend the energy absorption of titanium dioxide to visible light and to improve the photocatalytic activity of titanium dioxide. For example, foreign metallic elements such as silver can be added. This may, for example, aid electron-hole separation as the silver can serve as an electron trap, and can facilitate electron excitation by creating a local electric field. The use of silver, however, requires tempering the coating in a nitrogen environment to prevent the silver from oxidizing. Thus, adding silver to titanium dioxide coatings on a large scale is not a viable option due to the high costs.

Titanium dioxide also has been shown to exhibit highly hydrophilic properties when exposed to UV radiation. Such hydrophilicity may be beneficial in certain embodiments, such as, for example, certain coating embodiments. Without wishing to be limited in theory, it is believed that the photoinduced hydrophilicity is a result of photocatalytic splitting of water by the mechanism of the photocatalytic activity of the titanium dioxide, i.e., by the photogenerated electron-hole pairs. When exposed to UV radiation, the water contact angle of titanium dioxide coatings approaches 0°, i.e., superhydrophilicity.

Current coating methods involving titanium dioxide often result in a disadvantageous loss of hydrophilicity and/or photocatalytic activity such as antimicrobial and/or self-cleaning properties of the titanium dioxide. This may be due to formation of different phases of the titanium dioxide during the coating process. For example, anatase titanium dioxide typically transforms to rutile phase titanium dioxide when heated at temperatures which may be used during the coating process, such as temperatures greater than 600° C., such as may be used during the coating process. The rutile phase has less desirable surface coating properties than the anatase phase, such as, for example, less desirable hydrophilicity and antimicrobial and/or self-cleaning properties.

There is thus a long-felt need in the industry for methods for forming a titanium dioxide coating having increased photocatalytic activity, such as antimicrobial and/or self-cleaning properties and/or hydrophilicity, and/or a reduced dosing time. The invention described herein may, in various embodiments, solve some or all of these needs.

### SUMMARY

In accordance with various exemplary embodiments of the invention, methods for improving at least one of the hydrophilicity, activation time, and/or photocatalytic activity (and thus antimicrobial and/or self-cleaning properties) of titanium dioxide coatings have now been discovered.

Various exemplary embodiments of the invention relate to methods for forming anatase titanium dioxide coatings on roughened surfaces. At least one exemplary embodiment of the invention relates to methods for forming anatase titanium dioxide coatings comprising preparing a sol-gel composition, providing a substrate having a roughened surface, coating the roughened surface of the substrate with the sol-gel composition, and then heating the coating to form an anatase titanium dioxide coating.

Other exemplary embodiments of the invention relate to anatase titanium dioxide coatings having at least one improved property chosen from antimicrobial and/or self-cleaning properties, hydrophilicity, and/or activation time. Exemplary embodiments of the invention also include antimicrobial and/or self-cleaning coatings comprising anatase titanium coatings. Further embodiments include a substrate having a roughened surface coated with a titanium dioxide coating according to various exemplary embodiments of the invention.

As used herein, the phrase “roughened surface” means a surface that has a textured surface. The surface texture may be uniform or random. The degree or amount of surface roughening may be deter mined by any method known to those of skill in the art, such as, for example, using a mean square roughness, which is a measure of the deviation from an average height of the surface.

As used herein, “increased” or “improved photocatalytic activity” means any decrease in the activation time of, or any increase in the amount of organic material decomposed by, the titanium dioxide coating in a specified period of time when compared to coatings of the same composition not prepared on a roughened surface of a substrate. Similarly, “increased” or “improved antimicrobial properties” or “increased” or “improved self-cleaning properties” likewise mean any increase in the amount of organic material decomposed by the titanium dioxide coating in a specified period of time when compared to coatings of the same composition not prepared on a roughened surface of a substrate.

Throughout this disclosure, the terms “photocatalytic activity,” “antimicrobial properties,” and/or “self-cleaning properties” may be used interchangeably to convey that the antimicrobial and/or self-cleaning properties of the titanium dioxide coatings are a result of the photocatalytic activity of the coatings.

As used herein, “activation time” means the time required for a titanium dioxide coating illuminated with UV radiation to decompose a specified percentage of organic material over a period of time. Likewise, “decreased” or “reduced activation time” means any decrease in the amount of activation time required to decompose the specified percentage of organic material over a period of time when compared to coatings not according to various embodiments of the invention.

As used herein, “increased” or “improved hydrophilicity” means any decrease in the water contact angle when compared to coatings not according to various embodiments of the invention. The water contact angle is a measure of the angle between water and the surface of a material. A smaller water contact angle indicates a material that is more hydrophilic than a material with a higher water contact angle. Water droplets on more hydrophilic surfaces tend to spread out or flatten, whereas on less hydrophilic surfaces water tends to bead up or form droplets which are more spherical in shape, and the water contact angle of those surfaces is generally greater.

As used herein, the term “sol-gel composition” means a chemical solution comprising a titanium compound within the chemical solution that forms a polymerized titanium dioxide coating when the solvent is removed, such as by heating or any other means.

As used herein, the term “temperable” means a titanium dioxide coating that may be heated to a temperature sufficient to temper a substrate on which it is formed without forming rutile phase titanium dioxide.

As used herein, the term “laminate” means an object having a layered structure. For example, a laminate may comprise a substrate, such as a glass substrate having a roughened surface, and a coating, such as a sol-gel coating comprising colloidal metal oxide particles or colloidal silica particles, formed thereon. A laminate according to the present invention may be made by any process known in the art to produce layers or coatings.

As described herein, the invention relates to anatase titanium dioxide coatings formed on a substrate having a roughened surface, and methods of forming anatase titanium dioxide coatings on a substrate having a roughened surface. In the following description, certain aspects and embodiments will become evident. It should be understood that the invention, in its broadest sense, could be practiced without having one or more features of these aspects and embodiments. It should be understood that these aspects and embodiments are merely exemplary and explanatory, and are not restrictive of the invention as claimed.

### BRIEF DESCRIPTION OF THE DRAWINGS

The following figures, which are described below and which are incorporated in and constitute a part of the specification, illustrate exemplary embodiments of the invention and are not to be considered limiting of the scope of the invention, for the invention may admit to other equally effective embodiments.

FIG. 1 is a graph of a stearic acid test showing the amount of stearic acid remaining after UV exposure as a function of the mean square roughness of the substrate of the Examples; and

FIG. 2 is a graph of a stearic acid test showing the amount of stearic acid remaining after UV exposure as a function of the amount of etching agent used to prepare the roughened surface of the substrate of the Examples.

### DESCRIPTION OF EXEMPLARY EMBODIMENTS

Reference will now be made to various exemplary embodiments of the invention, examples of which are illustrated in the accompanying figures. However, these various exemplary embodiments are not intended to limit the disclosure, but rather numerous specific details are set forth in order to provide a thorough understanding of the invention. It will be apparent to one skilled in the art that the invention may be practiced without some or all of these specific details, and the disclosure is intended to cover alternatives, modifications, and equivalents. For example, well-known features and/or process steps may not have been described in detail so as not to unnecessarily obscure the invention.

The present invention contemplates various exemplary methods of forming anatase titanium dioxide coatings on a roughened surface, such as on a substrate having a roughened surface, in order to improve at least one of photocatalytic activity (and thus antimicrobial and/or self-cleaning properties), hydrophilicity, and/or activation time of the coating.

While not wishing to be bound by theory, it is believed that the roughened surface increases the number of attainable surface activation sites. An increase in the number of attainable surface activation sites may lead to (1) improved photocatalytic activity such as antimicrobial and/or self-cleaning properties because the number of radicals may be directly related to the amount of surface area available, and/or (2) improved hydrophilicity because the number of radicals which are present and are available to be attracted to the water molecules is greater.

At least one exemplary embodiment of the invention contemplates methods of forming anatase titanium dioxide coatings on a substrate having a roughened surface, where said methods comprise preparing a titanium dioxide sal-gel composition, providing a substrate having a roughened surface, coating a roughened surface of the substrate with the sal-gel composition, and heating the coating to form an anatase titanium dioxide coating.

The titanium dioxide sol-gel composition may be made by any method known to those of skill in the art. For example, in at least one exemplary embodiment, the titanium dioxide sal-gel composition may comprise a titanium alkoxide or a titanium chloride. Examples of titanium alkoxides which may be used in sal-gel compositions according to the present invention include, but are not limited to, titanium n-butoxide, titanium tetra-iso-butoxide (TTIB), titanium isopropoxide, and titanium ethoxide. In at least one embodiment, the titanium dioxide sol-gel composition comprises titanium tetra-iso-butoxide.

In at least one embodiment, the sol-gel composition further comprises a surfactant, which may improve the coating process. Examples of surfactants which may be used in accordance with the present invention include, but are not limited to, non-ionic surfactants such as alkyl polysaccharides, alkylamine ethoxylates, castor oil ethoxylates, ceto-stearyl alcohol ethoxylates, decyl alcohol ethoxylates, and ethylene glycol esters.

In various exemplary embodiments, a surface of the titanium dioxide coating may also be roughened. The surface of the titanium dioxide coating may be roughened by using a sol gel composition further comprising colloidal metal oxide particles or colloidal silica particles. The colloidal metal oxide particles or colloidal silica particles, if present, may have an average particle size as large as about 200 nm. According to at least one exemplary embodiment, the colloidal silica comprises silica particles having an average particle size less than 100 nm. In another exemplary embodiment, the silica particles have an average particle size of about 70 nm. One skilled in the art would appreciate that the choice of particle size depends on, for example, the particular particles chosen and the desired surface properties of the titanium dioxide coating. For example, smaller silica particle sizes may result in a lower surface roughness given a predetermined concentration of colloidal silica in the sol gel composition, while larger silica particle sizes may result in greater surface roughness at the same predetermined concentration of colloidal silica in the sol gel composition. Similarly, the choice of silica particle size may also be based on the desired thickness of the titanium dioxide coating. For a thinner titanium dioxide coating, it may be desirable to use smaller silica particles, whereas larger silica particles may be used for thicker titanium dioxide coatings. In at least one embodiment, the silica particles have a narrow size distribution.

In at least one exemplary embodiment of the invention, the sol gel composition comprises colloidal metal oxide or colloidal silica in an amount less than or equal to about 20 wt % relative to the total weight of the composition. In other embodiments, the sol gel composition comprises colloidal metal oxide or colloidal silica in an amount less than or equal to about 15 wt %, less than or equal to 10 wt %, less than or equal to 5 wt %, or less than or equal to 2 wt % relative to the total weight of the coating. In various embodiments, the sol gel composition comprises colloidal metal oxide or colloidal silica in an amount ranging from about 5 wt % to about 15 wt % relative to the total weight of the composition.

In other exemplary embodiments, a colloidal metal oxide or silica concentration greater than about 15 wt % can be used. One skilled in the art will appreciate that additional colloidal metal oxide or silica may result in increased surface roughness, but other effects may negatively impact the performance of the surface roughened titanium dioxide coating. For example, additional silica in the titanium dioxide coating may decrease the photocatalytic activity of the coating. Accordingly, the amount of colloidal metal oxide or colloidal silica which can be used in any specific embodiment of the invention may easily be determined by one of skill in the art, in view of the desired properties of the coating.

In at least one embodiment, the titanium dioxide coating on the roughened surface may have a thickness ranging from, for example, about 50 nm to about 500 nm. In at least one embodiment, the titanium dioxide coating on the roughened surface has a thickness ranging from about 100 nm to about 350 nm, or from about 150 nm to about 300 nm. One skilled in the art will appreciate that the thickness of the titanium dioxide coating may be chosen based on, for example, the desired properties of the coating, such as, for example, scratch resistance, durability, light transmission, etc.

According to various embodiments, at least one surface of a substrate may be roughened by any method known to those of skill in the art. By way of example only, at least one surface of a substrate may be roughened by chemically or mechanically etching the surface of the substrate according to any known means for etching a substrate. Examples of chemically etching the surface include, but are not limited to, etching with acids, such as hydrochloric acid, nitric acid, or other inorganic acids. Non-limiting examples of mechanical etching include sand-blasting and bead-blasting. In at least one exemplary embodiment, the surface of the substrate may be roughened by chemically etching the surface.

In one exemplary embodiment, the substrate may comprise a glass substrate. By way of example only, the glass substrate may be chosen from standard clear glass, such as float glass, matte/matte, and matte/prismatic, or a low iron glass, such as ExtraClear™, UltraWhite™, or Solar glasses available from Guardian Industries.

In various embodiments, the roughened surface of the substrate may exhibit a mean square roughness, as measured using an atomic force microscope (AFM) technique, ranging from 3.75 nm to 16 nm, such as, for example, from 3.75 nm to 7.5 nm. Surface roughening greater than 16 nm may also be achieved, although it may be at a cost of decreased light transmission and/or increased reflection. The desired mean square roughness would be within the abilities of one skilled in the art to determine based on, for example, the desired photocatalytic activity (which may include antimicrobial and/or self-cleaning properties), hydrophilicity, and/or activation time of the coating as balanced against the desired light transmission or reflection.

In various exemplary embodiments, the amount of roughness of a surface may be controlled. For example, where the surface of a substrate is roughened by chemically etching the surface, such as by using hydrochloric acid, the amount of roughness of the surface may be controlled by varying the strength or concentration of hydrochloric acid.

In at least one embodiment, the substrate may be coated with a sol-gel composition by a method chosen from spin-coating the sol-gel composition on the substrate, spray-coating the sol-gel composition on the substrate, dip-coating the substrate with the sol-gel composition, and any other technique known to those of skill in the art.

In one exemplary embodiment, the sol-gel coated substrate may be heated at a temperature of 500° C. or greater, such as 600° C. or greater, for example 625° C. or greater. In one exemplary embodiment, the sol-gel coated substrate may be heated for any length time sufficient to create a surface roughened anatase titanium dioxide coating, such as, for example, about 3-4 minutes, such as about 3½ minutes. One skilled in the art will appreciate, however, that other temperatures and heating times may be used and should be chosen such that anatase titanium dioxide coating is formed. For example, the titanium dioxide coatings according to exemplary embodiments of the invention as described herein may be heated at a temperature ranging from about 550° C. to about 650° C. The titanium dioxide coatings may be heated at lower temperatures as well, as long as anatase titanium dioxide is formed. Thus, one skilled in the art may choose the temperature and heating time based on, for example, the appropriate temperature and time for heating to form the anatase titanium dioxide coating, the properties of the desired titanium dioxide coating, such as thickness of the coating or thickness of the substrate, etc. For example, a thinner coating may require heating at a lower temperature or for a shorter time than a thicker coating. Similarly, a substrate that is thicker or has lower heat transfer may require a higher temperature or a longer time than a substrate that is thinner or has a high heat transfer. As used herein, the phrase “heated at” a certain temperature means that the oven or furnace is set at the specified temperature. Determination of the appropriate heating time and temperature is well within the ability of those skilled in the art, requiring no more than routine experimentation.

Temperable anatase titanium dioxide coatings may be formed according to at least one method of the present invention. For example, an anatase titanium dioxide coating formed on a glass substrate having a roughened surface may be heated at a temperature sufficient to temper the glass substrate without forming the rutile phase of titanium dioxide, i.e., the titanium dioxide remains in the anatase phase when the glass substrate is tempered.

The present invention also contemplates, in various embodiments, an anatase titanium dioxide coating formed on a roughened surface. Such coatings may, in certain embodiments, have properties chosen from increased photocatalytic activity (and thus antimicrobial and/or self-cleaning properties), hydrophilicity, and/or decreased activation time.

Various exemplary methods in accordance with the invention may improve at least one of hydrophilicity and photocatalytic activity such as antimicrobial and/or self-cleaning properties of the coatings.

In at least one embodiment, the titanium dioxide coating may be used as an antimicrobial and/or self-cleaning coating. Accordingly, a substrate having a roughened surface having improved antimicrobial and/or self-cleaning properties, coated with a titanium dioxide coating according to various embodiments of the invention, can be provided. Antimicrobial and/or self-cleaning coatings according to the present invention may be used, for example, on windows.

The present invention also contemplates an antimicrobial and/or self-cleaning laminate. According to at least one embodiment, the antimicrobial and/or self-cleaning laminate may comprise a substrate having a roughened surface, and a titanium dioxide coating on the roughened surface of the substrate.

The present invention also contemplates, in at least one embodiment, a titanium dioxide coating having improved hydrophilicity, such as, for example, when formed on a roughened surface of a substrate.

The present invention is further illustrated by the following non-limiting examples, which are provided to further aid those of skill in the art in the appreciation of the invention.

Unless otherwise indicated, all numbers herein, such as those expressing weight percents of ingredients and values for certain physical properties, used in the specification and claims are to be understood as being modified in all instances by the term “about,” whether so stated or not. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, a “wt %” or “weight percent” or “percent by weight” of a component, unless specifically stated to the contrary, is based on the total weight of the composition or article in which the component is included. As used herein, all percentages are by weight unless indicated otherwise.

It is noted that, as used in this specification and the appended claims, the singular forms “a,” “an,” and “the,” include plural referents unless expressly and unequivocally limited to one referent, and vice versa. Thus, by way of example only, reference to “a substrate” can refer to one or more substrates, and reference to “an acid” can refer to one or more acids. As used herein, the term “include” and its grammatical variants are intended to be non-limiting, such that recitation of items in a list is not to the exclusion of other like items that can be substituted or added to the listed items.

It will be apparent to those skilled in the art that various modifications and variation can be made to the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

### EXAMPLES

### Comparative Example

A titanium dioxide sol was prepared by mixing 12 grams of titanium tetra-iso-butoxide (TTIB) in a solution containing 50 g of ethanol and 0.24 grams of hydrochloric acid and 0.24 grams of water. The mixture was stirred for 3 hours. The pure titanium dioxide coating was fabricated by spin coating a glass substrate at 700 rpm for 30 seconds. The coating was heat treated in a furnace at 625° C. for 3.5 minutes. The formed titanium dioxide coating was pure anatase phase titanium dioxide. The uncoated glass substrate had mean square roughness of 3.51 nm. The uncoated substrate had a visible light transmission of 85.2% and reflection at the film side of 15.34%.

The photocatalytic activity of the examples disclosed herein was tested using a stearic acid test that measured the degradation of stearic acid on the anatase titanium dioxide coatings. To perform the stearic acid test, an 8.8×10⁻³ M stearic acid/methanol solution was prepared. The stearic acid/methanol solution was spin coated on the surface of the anatase titanium dioxide coating at 2000 rpm for 30 seconds. The stearic acid concentration was measured with a Nicolet 6700 FT-IR spectrometer by integrating the absorption peaks of the stearic acid molecule between 2700 and 3100 cm⁻¹. Stearic acid concentration was then measured at various time intervals of UV illumination of the anatase titanium dioxide coating. Two UV lamps with 1300 μW/cm² and wavelength of 340 nm were used for UV irradiation.

The titanium dioxide coating of the Comparative Example had 16.05% of the stearic acid after exposing the coating to UV radiation for 5 hours. After 20 hours of UV exposure. 15.34% of the stearic acid was left on the titanium dioxide coating of the Comparative Example.

### Example 1

The titanium dioxide sol used to prepare the titanium dioxide coating of Example 1 was prepared similar to the titanium dioxide sol of the Comparative Example.

The glass substrate of Example 1 was etched using 2 wt % of hydrochloric acid in water for 24 hours on one side of the glass substrate. The mean square roughness of the uncoated etched surface was 3.79 nm. The visible light transmission and reflectance at the film side of the uncoated etched substrate were 81.2% and 19.06%, respectively.

The titanium dioxide coating was applied using spin-coating and heat-treating as described above for the Comparative Example. After 5 hours of UV exposure during the stearic acid test, the titanium dioxide coating of Example 1 had 14.77% of the stearic acid remaining. After 20 hours, the stearic acid concentration was 6.70°/h.

### Example 2

The titanium dioxide sol used to prepare the titanium dioxide coating of Example 2 was prepared similar to the titanium dioxide sol of the Comparative Example.

The glass substrate of Example 2 was etched using 8 wt % of hydrochloric acid in water for 24 hours on one side of the glass substrate. The mean square roughness of the uncoated etched surface was 3.97 nm. The visible light transmission and reflectance at the film side of the uncoated etched substrate were 80.5% and 19.86%, respectively.

The titanium dioxide coating was applied using spin-coating and heat-treating as described above for the Comparative Example. After 5 hours of UV exposure during the stearic acid test, the titanium dioxide coating of Example 2 had 13.48% of the stearic acid remaining. After 20 hours, the stearic acid concentration was 4.75% of the starting concentration.

### Example 3

The titanium dioxide sol used to prepare the titanium dioxide coating of Example 3 was prepared similar to the titanium dioxide sol of the Comparative Example.

The glass substrate of Example 3 was etched using 12 wt % of hydrochloric acid in water for 24 hours on one side of the glass substrate. The mean square roughness of the uncoated etched surface was 5.01 nm. The visible light transmission and reflectance at the film side of the uncoated etched substrate were 80.1% and 20.5%, respectively.

The titanium dioxide coating was applied using spin-coating and heat-treating as described above for the Comparative Example. After 5 hours of UV exposure during the stearic acid test, the titanium dioxide coating of Example 3 had 13.90% of the stearic acid remaining. After 20 hours, the stearic acid concentration was 3.58% of the starting concentration.

### Example 4

The titanium dioxide sol used to prepare the titanium dioxide coating of Example 4 was prepared similar to the titanium dioxide sol of the Comparative Example.

The glass substrate of Example 4 was etched using 16 wt % of hydrochloric acid in water for 24 hours on one side of the glass substrate. The mean square roughness of the uncoated etched surface was 6.45 nm. The visible light transmission and reflectance at the film side of the uncoated etched substrate were 79.3% and 21.19%, respectively.

The titanium dioxide coating was applied using spin-coating and heat-treating as described above for the Comparative Example. After 5 hours of UV exposure during the stearic acid test, the titanium dioxide coating of Example 4 had 12.64% of the stearic acid remaining. After 20 hours, the stearic acid concentration was 1.08% of the starting concentration.

### Example 5

The titanium dioxide sol used to prepare the titanium dioxide coating of Example 5 was prepared similar to the titanium dioxide sol of the Comparative Example.

The glass substrate of Example 5 was etched using 100 wt % of hydrochloric acid for 24 hours on one side of the glass substrate. The mean square roughness of the uncoated etched surface was 7.35 nm. The visible light transmission and reflectance at the film side of the uncoated etched substrate were 79% and 21.18%, respectively.

The titanium dioxide coating was applied using spin-coating and heat-treating as described above for the Comparative Example. After 5 hours of UV exposure during the stearic acid test, the titanium dioxide coating of Example 5 had 9.69% of the stearic acid remaining. After 20 hours, the stearic acid concentration was 0.39% of the starting concentration.

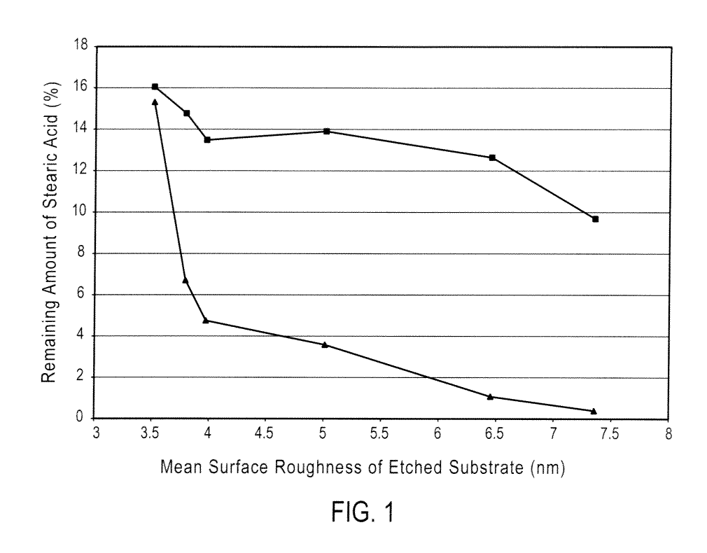

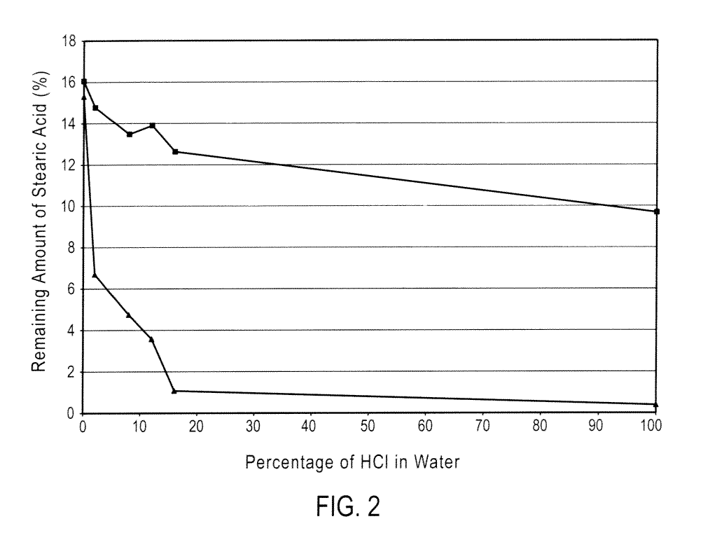

As demonstrated by Examples 1-5, the roughened surface of the substrate increased the photocatalytic activity of the anatase titanium dioxide coating. The amount of stearic acid left on the titanium dioxide coatings of the Comparative Example and Examples 1-5 is shown as a function of the amount of etching of the roughened surface of the substrate in FIG. 1, where the amount of stearic acid present after 5 hours is represented by squares and the amount of stearic acid present after 20 hours is represented by triangles. The concentration of stearic acid remaining as a function of the amount of hydrochloric acid used to etch the surface of the substrate is shown in FIG. 2, where the amount of stearic acid present after 5 hours is represented by squares and the amount of stearic acid present after 20 hours is represented by triangles.

What is claimed is:

1. A method of improving at least one of antimicrobial properties, self-cleaning properties, hydrophilicity, and activation time of a titanium dioxide coating, said method comprising:
preparing a titanium dioxide sol-gel composition;
providing a substrate having a roughened surface;
coating the roughened surface of the substrate with the sol-gel composition; and
heating the coated substrate to form an anatase titanium dioxide coating.

2. The method of claim 1, wherein the roughened surface of the substrate is formed by etching the surface of the substrate chemically or mechanically.

3. The method of claim 2, wherein the roughened surface of the substrate is formed by etching the surface of the substrate with an acid.

4. The method of claim 1, wherein the acid is chosen from hydrochloric acid and nitric acid.

5. The method of claim 1, wherein the roughened surface of the substrate has a mean square roughness ranging from about 3.75 nm to about 16 nm.

6. The method of claim 1, wherein the substrate is glass.

7. The method of claim 6, wherein the substrate is chosen from clear glass and low-iron glass.

8. The method of claim 1, wherein the coated substrate is heated at a temperature of about 600° C. or greater.

9. The method of claim 1, wherein the anatase titanium dioxide coating further comprises a roughened surface.

10. A method of forming an anatase titanium dioxide coating on a roughened surface of a substrate, said method comprising;
preparing a titanium dioxide sol-gel composition;
providing a substrate having a roughened surface;
coating the roughened surface of the substrate with the sol-gel composition; and
heating the coated substrate to form an anatase titanium dioxide coating.

11. The method of claim 10, wherein the roughened surface of the substrate is formed by etching the surface of the substrate chemically or mechanically.

12. The method of claim 11, wherein the roughened surface of the substrate is formed by etching the surface of the substrate with an acid.

13. The method of claim 12, wherein the acid is chosen from hydrochloric acid and nitric acid.

14. The method of claim 10, wherein the roughened surface of the substrate has a mean square roughness ranging from about 3.75 nm to about 16 nm.

15. The method of claim 10, wherein the substrate comprises a glass substrate.

16. The method of claim 15, wherein the glass substrate is chosen from clear glass and low-iron glass substrates.

17. The method of claim 10, wherein the coated substrate is heated at a temperature of about 600° C. or greater.

18. The method of claim 10, wherein the anatase titanium dioxide coating further comprises a roughened surface.

19. An antimicrobial and/or self-cleaning laminate, comprising:
a substrate having a roughened surface;
an anatase titanium dioxide coating on the roughened surface of the substrate.

20. The antimicrobial and/or self-cleaning laminate of claim 19, wherein the roughened surface of the substrate has a mean square roughness ranging from about 3.75 nm to about 16 nm.

21. A titanium dioxide-coated substrate, wherein said titanium dioxide coating is made by:
preparing a titanium dioxide sol-gel composition;
providing a substrate having a roughened surface;
coating the roughened surface of the substrate with the sol-gel composition; and
heating the coated substrate to form an anatase titanium dioxide coating.
